(19) United States
(12) Patent Application Publication
(10) Pub. No.: US 2016/0050586 A1
(43) Pub. Date: Feb. 18, 2016

(54) DATA PRIORITIZATION FOR WIRELESS NETWORKS

(71) Applicant: Naddive, LLC, Westminster, CO (US)

(72) Inventors: Scott MILLER, Bellevue, WA (US); Shankarachary RAGI, Columbus, IN (US)

(73) Assignee: NADDIVE, LLC, Westminster, CO (US)

(21) Appl. No.: 14/824,838

(22) Filed: Aug. 12, 2015

Related U.S. Application Data
(60) Provisional application No. 62/036,295, filed on Aug. 12, 2014.

(51) Int. Cl. H04W 28/02; H04L 12/851; H04L 12/825

(52) U.S. Cl. CPC H04W 28/0289; H04L 47/25; H04L 47/2433

(57) ABSTRACT

A method and device for priority sorting and transmission of data signals including a prioritization engine which reduces congestion of a data stream by prioritizing video data packets in proportion to non-video packets at established ratios.

### CROSS-REFERENCE TO RELATED APPLICATIONS

This patent application claims priority to U.S. Provisional patent application Ser. No. 62/036,295, filed Aug. 12, 2014.

### BRIEF DESCRIPTION OF THE SEVERAL DRAWINGS

FIG. 1 is a flow chart of the disclosed method;

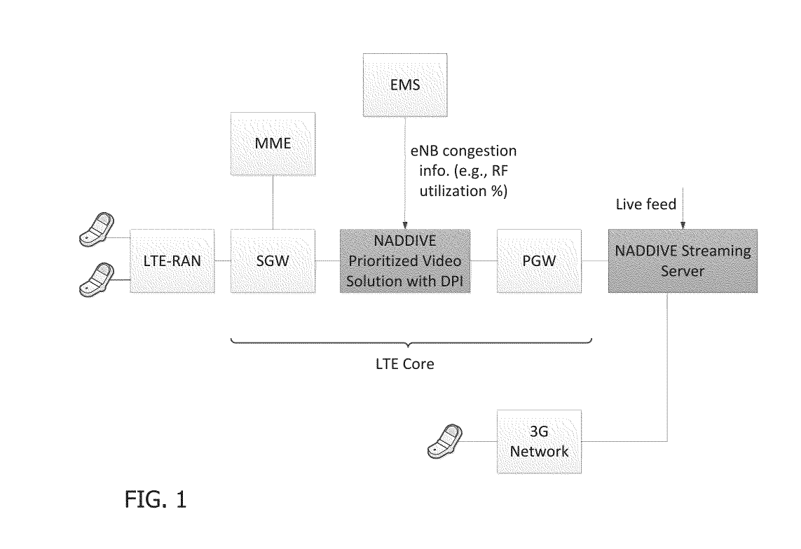

FIG. 2 is a flow chart of the end to end architecture of the disclosure;

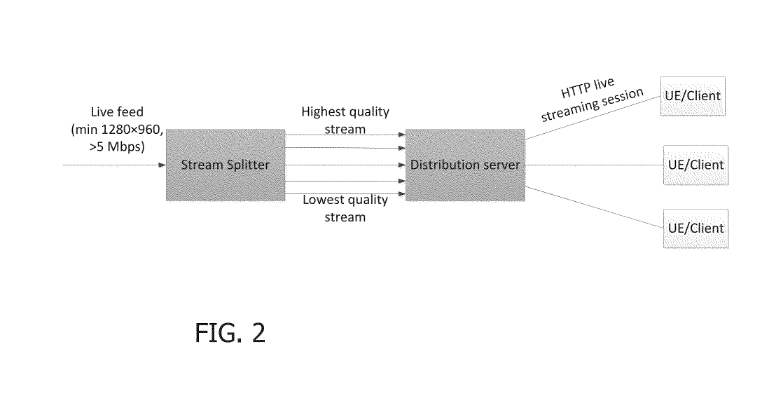

FIG. 3 is flow chart of the prioritized video method with DPI; and

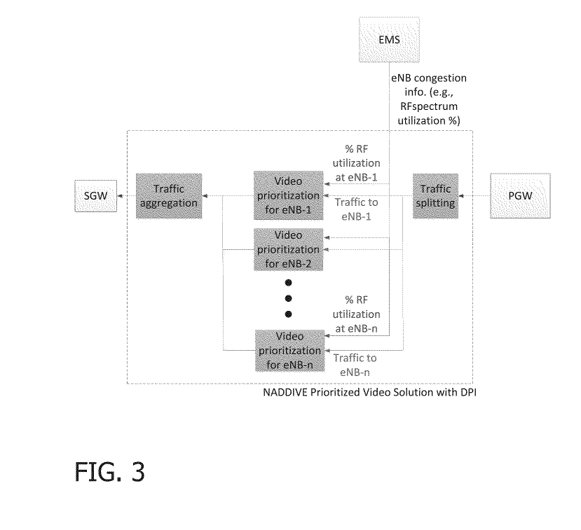

FIG. 4 is a flow chart of the prioritized video node used in the disclosed method for eNB-k.

### DETAILED DESCRIPTION OF PREFERRED EMBODIMENTS

Increasing numbers of devices dependent on wireless networks for data have resulted in congestion in those networks, most especially at the cellular towers which must deliver the data to multiple devices using radio frequency waves. Even in wired networks, bottlenecks can occur during times of very high usage.

While most users are annoyed at service disruptions and delays, the problem is especially acute for users who are using a network to access time-sensitive data such as video. When video packets are not delivered in a timely fashion, the image on the screen can freeze, pixelate, or go dark. For viewers of live events, such as television premiers or sporting events, this is potentially a major source of dissatisfaction. For particularly popular events, the network is likely to be congested due to large numbers of users, and any outages or delays are likely to irritate large numbers of customers. Even in non-video contexts, sometimes particular data is unusually time sensitive, such as point of sale data for scare products (for instance, tickets to a concert that are likely to sell out quickly) or instructions to buy or sell securities. It would therefore be useful to find a way to deliver both popular and time-critical data reliably even during times of high congestion.

In some network architectures, data packets flowing towards users may encounter a first gateway that interfaces with the Internet or other networks to send requests and receive data many sources. These packets are then placed in a queue and transmitted to another gateway, typically on a First In First Out (FIFO) basis. The second gateway distributes the packets to the routers which have requested them, for further distribution to devices operated by end users. In one embodiment, these routers may be the nodes of a cellular telephone network, and the devices may be wireless devices such as smartphones, tablet computers, or computers equipped with cellular data modems.

Due to the finite and non-expandable bandwidth inherent in radio-frequency communications, cellular network nodes may become congested and develop backlogs in data packet transmission. For end users who are attempting to use large quantities of bandwidth, this can cause frustrating delays. In particular, video streamed to wireless devices can degrade in quality or halt unexpectedly while the wireless device waits for the next packet to arrive from the congested queue. This is especially problematic for users watching sporting events, where live action is at a premium. Of course, many other forms of data transfer may also be adversely affected by congestion, and that congestion need not originate due to limited radio spectrum; any bottleneck having limited bandwidth may pose a problem to end users.

To solve this problem, a prioritization engine may be placed between the first and second gateways in a network. The prioritization engine can receive information on congestion downstream and in response prioritize certain packets over others. Packets considered a high priority may be passed to the front of the queue by the prioritization engine, and thus transmitted the second gateway before lower-priority packets. The high-priority packets will thus have a higher chance of reaching their destination in a timely fashion.

A prioritization engine may be advantageously combined with multicasting techniques. In one form of multicasting, single data packets are transmitted from a source, intended to reach multiple users. The packets are duplicated only at those points in the network where duplication is required. For illustration, consider a streaming video of a live event intended to be transmitted to wireless devices in the hands of multiple endusers. In a simplified example, a single packet of video data is generated at the source. This packet is transmitted to the first gateway of a cellular network, which places it in a queue and sends it to a second gateway. Although the packet is intended for a large audience, it is not duplicated. The second gateway, which serves multiple cell nodes, makes one copy of the packet for each of those nodes and transmits these copies to them. The nodes then make additional copies of the packet, one for each device which has requested the video. In this way, the bandwidth required to get the packet from the source to the cellular node is.

When a prioritization engine is combined with a multicasting technique, the number of high-priority packets emerging from the first gateway and being moved up in the queue is minimized. This removes one possible source of congestion and reduces the complexity and power requirements of the prioritization engine.

A prioritization engine may also be advantageously combined with a server that adjusts its transmission rate in response to congestion. A lower bit rate means lowered quality in a streaming service such as video, which is to be avoided if possible. However, when congestion is very high, some degree of degradation may be inevitable. The prioritization engine can selectively reduce the degree of congestion for one particular data stream, thus maximizing quality. This effect is particularly advantageous when lower-priority packets constitute non-time sensitive data, such as static photographs, text, or similar items. In such cases, a lowered transmission rate means an increase in download time, but no change in the quality ultimately delivered. Prioritizing video delivery thus maximizes the experience of video consumers while having only a small impact on non-video end users.

The preceding examples have divided data into only two forms, high priority and low priority, and have given the high-priority data an absolute preference in the queue. When such a technique is applied at times of high congestion, it may cause transmission of low-priority packets to cease altogether. Since that is likely to lead to customer dissatisfaction, several alternative techniques may be employed.

First, it is possible to establish a rule that at least 1/N of the packets passed through the prioritization engine be a low-priority packet. N may then be selected so as to balance the degradation in quality for both the high-priority and the low-priority transmitted data. Alternatively, a dynamic scheduling algorithm may be employed that considers the amount of buffering available on user devices, and attempts to use these buffers to minimize delays. Thus during periods of lower congestion, low-priority packets may be passed through at a higher rate, so that when congestion rises and high-priority packets must be preferentially transmitted, the buffered data from the earlier-transmitted low-priority packets can minimize disruption for users.

Furthermore, it is possible to establish multiple levels of priority. Instead of a data stream composed of 1/N low-priority packets, it could instead consist of X % packets of Class 1, Y % of Class 2, and Z % of Class 3 packets, where X, Y, and Z are chosen based on the relative importance of packets of these classes. These classes and their proportions could be adjusted based on many factors, and could vary throughout the day or from day to day based on user preferences. Thus, for instance, packets showing video of the Superbowl live would get higher priority than either those of an ordinary regular-season game, or clips of past Superbowls, because the number of interested views is likely to be much higher, but on the other hand any video packets could receive higher priority than text or static photographs, where delivery is not nearly as time-sensitive.

The use of priority in scheduling the delivery of packets may be based on various factors. For instance, priority may be adjusted based simply on the number of users requesting a particular feed. If a large number of people are seeking to obtain a particular data stream at the same time, a cellular service company or other provider may decide to satisfying that large customer segment is more important that serving other, smaller segments requesting less-popular feeds. Alternatively, priority could be decided based upon subscription levels. Customers willing to pay more would expect faster delivery of their data. A third possibility might be a pay-per-view model, in which customers pay for priority delivery of a particular data stream, for example a particular sporting event, but at other times receive lower priority service. In other embodiments, priority could be decided based upon the perceived urgency of the data. For instance, tactical communications used by emergency services could be given priority over more routine network uses, ensuring effective communication for police, fire, and EMS personal responding to a serious crisis, but still permitting the use of the network by, for instance, police in another part of the service area conducting traffic stops.

In one embodiment, the prioritization engine may be employed in a 4G LTE wireless network. A detailed description of that embodiment follows.

As used herein, the acronyms below have the following definitions:

LTE: Long-term evolution (a 3GPP 4G cellular technology)

RAN: Radio access network

MME: Mobile management entity

SGW: Serving gateway

EMS: Element management system

PGW: PDN (packet data network) gateway

eNB: Evolved Node B

DPI: Deep packet inspection

RF: Radio frequency

UE: User equipment (e.g., cell phone)

GTP: GPRS tunnel protocol

A stream splitter is a logical node, where the HD quality (min 1280×960, >5 Mbps) live feed is split into multiple streams with varying video/audio bitrates and resolutions. The video is encoded using H.264 Baseline 3.0 Compression and AAC compression is used for audio. The following is a list of recommended encoding streaming formats.

Formats for 16:9 aspect ratio:

| | | | |
|---|---|---|---|
| Dimensions | Total bit rate | Video bit rate | Keyframes |

| 400 × 224 | 64 | kbps | Audio only | | None |
|---|---|---|---|---|---|
| 400 × 224 | 150 | kbps | 110 | kbps | 30 |
| 400 × 224 | 240 | kbps | 200 | kbps | 45 |
| 400 × 224 | 440 | kbps | 400 | kbps | 90 |
| 640 × 360 | 640 | kbps | 600 | kbps | 90 |
| 640 × 360 | 1240 | kbps | 1200 | kbps | 90 |
| 960 × 540 | 1840 | kbps | 1800 | kbps | 90 |
| 1280 × 720 | 2540 | kbps | 2500 | kbps | 90 |
| 1280 × 720 | 4540 | kbps | 4500 | kbps | 90 |

Formats for 4:3 aspect ratio:

| | | | |
|---|---|---|---|
| Dimensions | Total bit rate | Video bit rate | Keyframes |

| 400 × 300 | 64 | kbps | Audio only | | None |
|---|---|---|---|---|---|
| 400 × 300 | 150 | kbps | 110 | kbps | 30 |
| 400 × 300 | 240 | kbps | 200 | kbps | 45 |
| 400 × 300 | 440 | kbps | 400 | kbps | 90 |
| 640 × 480 | 640 | kbps | 600 | kbps | 90 |
| 640 × 480 | 1240 | kbps | 1200 | kbps | 90 |
| 960 × 720 | 1840 | kbps | 1800 | kbps | 90 |
| 960 × 720 | 2540 | kbps | 2500 | kbps | 90 |
| 1280 × 960 | 4540 | kbps | 4500 | kbps | 90 |

A distribution server is a media server, which serves clients (UE applications) via HTTP Live Streaming (HLS) protocol. At this node, multiple streams provided by Stream Splitter are buffered. When a HLS session is established with a client, the session has access to multiple streams. Typically, during a HLS session, the client software intelligently hops between streams with varying bitrates depending on the network bandwidth. This server can serve clients from 3G networks as well, but QoE can be guaranteed only if the client is from LTE.

A typical encoder takes audio+video input and encodes using H.264 video and AAC audio and creates an MPEG-2 transport stream. This stream is broken into small segments called Media Segments, which are indexed and stored on web servers. The URL for this index file is published on our web server, and when a client reads the index, the media segments are displayed at the client side without any gaps or pauses.

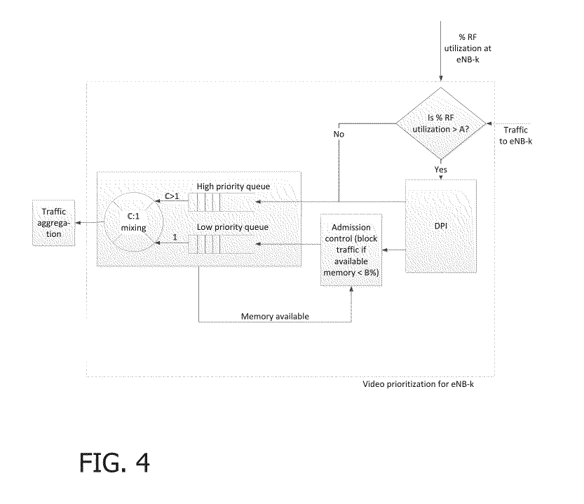

This node provides prioritization of traffic from NADDIVE's server over traffic from other sources by using congestion information at eNodeBs, e.g., % RF spectrum utilization. This node consists of several internal nodes: Traffic Splitting, Video Prioritization (multiple), Traffic Aggregation. The Traffic Splitting node categorizes (or splits) the packet traffic from PGW into n lanes of traffic, where lane k corresponds to traffic going to eNodeB-k (there are a total of n eNodeBs). This splitting can be done by inspecting the destination address (corresponding to a eNodeB) in GTP-Uv1 packet headers via DPI. Note that the IP packets received at PGW from outside networks (Internet) are encapsulated inside a GTP-Uv1 header (GPRS Tunnel Protocol-User Data Version-1 is typically used for routing data packets inside an LTE core network) with eNodeB's IP address as the destination address. The lane k traffic is fed to a “Video Prioritization” node (details of this node are described later), which provides prioritization of traffic that is going to eNodeB-k based on the congestion information for eNodeB-k received from EMS (Element Management System). The Traffic Aggregation node aggregates the traffic from each of the Video Prioritization node, and sends the traffic to SGW. FIG. 4 shows the architecture of a Video Prioritization node.

If the % RF spectrum utilization is greater than A % (meaning congestion) at the eNodeB, then the packets are classified and fed into high priority and low priority queues. This classification can be done by inspecting packet headers, via Deep Packet Inspection, and checking if a packet is from a NADDIVE Streaming Server. We mix the packets from high priority (packets from NADDIVE Streaming Server) and low priority (packets from other servers) queues at a ratio of C:1 (typically C>>1), in other words, we prioritize the data from the NADDIVE Streaming Server over general data packets. If C is constant, and if high priority packet arrival rate is more than C times that of low priority packet arrival rate, then the packets from high priority queue would be dropped. If at all packets are being dropped, we want the dropped packets to be low priority ones. To ensure this, we control the value of C (>Cmin) adaptively (proportional to the ratio of arrival rates of high priority and low priority queues) so that high priority queue is served faster when high priority queue is increasing faster compared to the low priority queue. If the % RF spectrum utilization is less than A %, then the traffic bypasses the above processing, and is fed directly to Traffic Aggregation node. In the above flow chart, the default values of A, B, and C may be 75, 5, and 200. The network administrators are allowed to change these values if needed.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A device for priority sorting and transmission of data signals comprising,
(a) a prioritization engine,
(b) a server that adjusts its transmission rate in response to congestion;
where the prioritization engine selectively reduces the degree of congestion for a first data stream by prioritizing data packets including video content over data packets lacking video content by determining if % RF spectrum utilization is greater than A % at an eNodeB, and, if yes, then the data packets containing video are fed into a high priority queue and data packets lacking video are fed into a low priority queue, and transmitting packets from high priority queue and low priority queue at a ratio of C:1, where C>>1, and where the value of C is controlled to a constant (>Cmin);
and where A=75; B=5; and C=200.

2. A device for priority sorting and transmission of data signals comprising,
(a) a prioritization engine,
(b) a server that adjusts its transmission rate in response to congestion;
where the prioritization engine selectively reduces the degree of congestion for a first data stream by prioritizing data packets including video content over data packets lacking video content by determining if % RF spectrum utilization is less than A % at an eNodeB, then the data packets containing are fed directly to a Traffic Aggregation node for transmission; and where A=75; B=5; and C=200.
